(19) United States
(12) Patent Application Publication
(10) Pub. No.: US 2008/0186257 A1
(43) Pub. Date: Aug. 7, 2008

(54) Plasma display device and driving method thereof

(75) Inventors: Jung-Jin Choi, Suwon-si (KR); Kwang-Ho Jin, Suwon-si (KR); Sang-Young Lee, Suwon-si (KR)

Correspondence Address: LEE & MORSE, P.C., 3141 FAIRVIEW PARK DRIVE, SUITE 500, FALLS CHURCH, VA, 22042, US

(73) Assignee: Samsung SDI Co., Ltd.

(21) Appl. No.: 12/068,445

(22) Filed: Feb. 6, 2008

(30) Foreign Application Priority Data
Feb. 7, 2007 (KR) 10-2007-0012671

(51) Int. Cl. G09G 3/28

(52) U.S. Cl. 345/60

(57) ABSTRACT

A method of driving (a plasma display device having a first electrode and a second electrode, a frame for display being divided into a plurality of subfields) includes: determining a number of sustain discharge pulses to be allocated to the subfields, respectively; and applying to the first electrode or the second electrode, during a sustain period for a given one of the subfields when the corresponding allocated number of sustain discharge pulses is greater than a reference number, a first quantity of first sustain discharge pulses each having a first cycle and a second quantity of second sustain discharge pulses each having a second cycle, the second cycle being different from the first cycle, and the first quantity of first sustain discharge pulses relating to the reference number.

### BACKGROUND OF THE INVENTION

1. Field of the Invention

One or more embodiments of the present invention relate to a plasma display device and a driving method thereof.

2. Description of the Related Art

A plasma display device is a flat panel display that uses plasma generated by a gas discharge to display characters or images. It includes a plasma display panel (PDP) wherein tens to millions of discharge cells are arranged in a matrix format, depending on its size.

Generally, in a plasma display device, a field (e.g., 1 TV field) is divided into respectively weighted subfields, and each subfield includes a reset period, an address period, and a sustain period with respect to time.

The reset period is for initializing the status of each discharge cell so as to facilitate an addressing operation on the discharge cell. The address period is for selecting turn-on/turn-off cells (i.e., cells to be turned on/off) and accumulating wall charges to the turn-on cells (i.e., addressed cells). The sustain period is for causing a discharge for displaying an image on the addressed cells.

A luminance level is determined by a sustain discharge pulse applied to a plurality of discharge cells in the sustain period. When a relatively small number of sustain discharge pulses are applied to the discharge cells, the luminance level is increased in proportion to the number of sustain discharge pulses. However, when a relatively large number of sustain discharge pulses are applied to the discharge cells, the luminance is maximized rather than being increased in proportion to the number of sustain discharge pulses since a phosphor coated over an address electrode is saturated as time passes. Accordingly, a grayscale inversion phenomenon or a luminance inversion phenomenon may be generated.

### SUMMARY OF THE INVENTION

Embodiments of the present invention are therefore directed to a plasma display device and a driving method thereof which substantially overcome one or more of the disadvantages of the related art.

It is therefore a feature of an embodiment of the present invention to provide a plasma display device that advantageously is less susceptible (if not immune) to a reduction in luminance regardless of the number of sustain discharge pulses generated during a given sustain period. Such an advantage can be achieved, e.g., by increasing a period of those sustain discharge pulses generated after the count of sustain discharge pulses exceeds a reference number.

At least one of the above and other features and advantages of embodiments may be realized by providing a method (of driving a plasma display device having a first electrode and a second electrode, a frame for display being divided into a plurality of subfields) includes: determining a number of sustain discharge pulses to be allocated to the subfields, respectively; and applying to the first electrode or the second electrode, during a sustain period for a given one of the subfields when the corresponding allocated number of sustain discharge pulses is greater than a reference number, a first quantity of first sustain discharge pulses each having a first period and a second quantity of second sustain discharge pulses each having a second period, the second period being different from the first period, and the first quantity of first sustain discharge pulses relating to the reference number.

An example embodiment of the present invention provides a plasma display device that includes a plasma display panel (PDP) and a controller. The PDP has a first electrode and a second electrode. The controller is operable to do at least the following: divide one frame into a plurality of subfields; determine a number of sustain discharge pulses to be allocated to the subfields, respectively; and apply to the first electrode or the second electrode, during a sustain period for a given one of the subfields when the corresponding allocated number of sustain discharge pulses is greater than a reference number, a first quantity of first sustain discharge pulses each having a first period and a second quantity of second sustain discharge pulses each having a second period; the second period being different from the first period; and the first quantity of first sustain discharge pulses relating to the reference number.

### BRIEF DESCRIPTION OF THE DRAWINGS

The above and other features and advantages of the present invention will become more apparent to those of ordinary skill in the art by describing in detail example embodiments thereof with reference to the attached drawings, in which:

FIG. 1 illustrates a schematic view of a plasma display device according to an example embodiment of the present invention.

FIG. 2 illustrates a driving method of the plasma display device according to an example embodiment of the present invention.

FIG. 3 illustrates a block diagram of a controller 200 according to an example embodiment of the present invention.

FIG. 4 illustrates an operational flowchart of the controller 200 according to an example embodiment of the present invention.

FIG. 5A and FIG. 5B illustrate a sustain pulse in a sustain period according to the example embodiment of the present invention.

FIG. 6A to FIG. 6C illustrate a driving type of a sustain discharge pulse in a sustain period according to the example embodiment of the present invention.

### DETAILED DESCRIPTION OF THE INVENTION

Korean Patent Application No. 10-2007-0012671 filed on Feb. 7, 2007, in the Korean Intellectual Property Office, and entitled: “Plasma Display Device and Driving Method Thereof,” is incorporated by reference herein in its entirety.

Example embodiments of the present invention will now be described more fully hereinafter with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

In the figures, the dimensions of layers and regions may be exaggerated for clarity of illustration. It will also be understood that when an element is referred to as being “on” another element, it can be directly on the other element, or intervening elements may also be present. Further, it will be understood that when an element is referred to as being “under” another element, it can be directly under, and one or more intervening elements may also be present. In addition, it will also be understood that when an element is referred to as being “between” two elements, it can be the only layer between the two elements or one or more intervening elements may also be present. Like reference numerals refer to like elements throughout.

In addition, unless explicitly described to the contrary, the word “comprise” and variations such as “comprises” or “comprising” will be understood to imply the inclusion of stated elements but not the exclusion of any other elements.

Wall charges mentioned in the following description mean charges formed and accumulated on a wall (e.g., a dielectric layer) close to an electrode of a discharge cell. A wall charge will be described as being “formed” or “accumulated” on the electrodes, although the wall charges do not actually touch the electrodes. Further, a wall voltage means a potential difference formed on the wall of the discharge cell by the wall charge.

A plasma display device and a driving method thereof according to an example embodiment of the present invention will now be described in more detail with reference to the accompanying drawings.

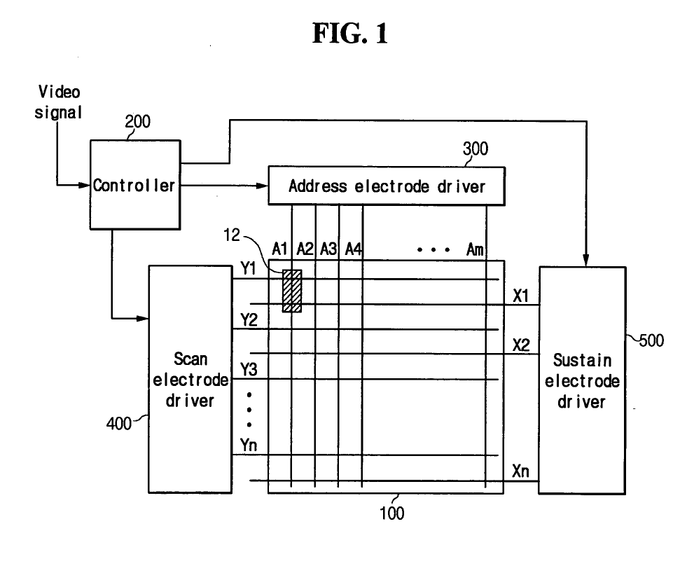

FIG. 1 illustrates a schematic view of a plasma display device according to an example embodiment of the present invention.

As shown in FIG. 1, the plasma display device may include a plasma display panel (PDP) 100, a controller 200, an address electrode driver 300, a scan electrode driver 400, and a sustain electrode driver 500.

The PDP 100 may include a plurality of address electrodes A1 to Am extending in a column direction, and a plurality of sustain electrodes X1 to Xn and a plurality of scan electrodes Y1 to Yn extending in a row direction as pairs, e.g., an i^{th} pair Xi & Yi. Generally, the sustain electrodes X1 to Xn are respectively formed corresponding to the scan electrodes Y1 to Yn, and the sustain electrodes X1 to Xn the scan electrodes Y1 to Yn perform a display operation in order to display an image during a sustain period. The address electrodes A1 to Am may perpendicularly cross the sustain electrodes X1 to Xn and the scan electrodes Y1 to Yn. A discharge space formed at a crossing region of the address electrodes A1 to Am with the sustain and scan electrodes Y1 to Yn and X1 to Xn forms a discharge cell 12. This structure of the PDP 100 is merely an example, and panels of other structures may be used as well.

The controller 200 may receive an external video signal and may output an address electrode driving control signal, a sustain electrode driving control signal, and a scan electrode driving control signal. In addition, the controller 200 may divide one frame into a plurality of subfields. Each subfield may include a reset period, an address period, and a sustain period in a temporal manner.

In further detail, the controller 200 may calculate the number of sustain discharge pulses to be allocated to each subfield by using an externally input video signal. In addition, the controller 200 may set all sustain discharge pulses to a first pulse width when the number of sustain discharge pulses allocated to a given subfield is less than a reference number. However, when the number of sustain discharge pulses allocated to a given subfield is greater than the reference number, the controller 200 may partially set the sustain discharge pulses to a first pulse width and the rest of the sustain discharge pulses to a second pulse width that is greater than the first pulse width.

The address driver 300 may receive the address electrode driving control signal from the controller 200 and may apply a display data signal to the respective address electrodes for selecting discharge cells to be displayed.

The scan electrode driver 400 may receive the scan electrode driving control signal from the controller 200 and may apply a driving voltage to the scan electrode.

The sustain electrode driver 500 may receive the sustain electrode driving control signal from the controller 200 and may apply a driving voltage to the sustain electrode.

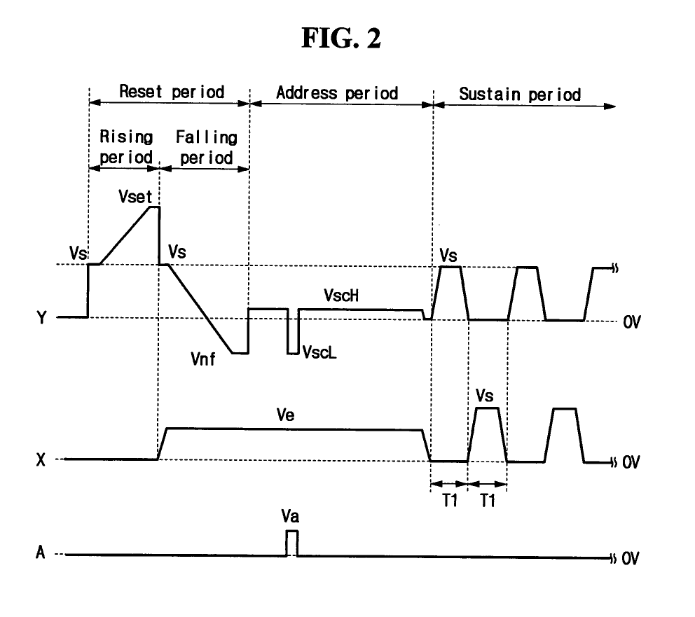

Driving waveforms applied to the address electrodes A1 to Am, the sustain electrodes X1 to Xn, and the scan electrodes Y1 to Yn will be described with reference to FIG. 2. Hereinafter, a driving waveform applied to an address electrode, a sustain electrode, and a scan electrode that form one cell will be described, and the address electrode, the scan electrode, and the sustain electrode will be respectively referred to as an A electrode, a Y electrode, and an X electrode for better understanding and ease of description.

FIG. 2 illustrates a driving method of the plasma display device according to an example embodiment of the present invention.

As shown in FIG. 2, a driving period may include a sequence of reset period, an address period and a sustain period. The reset period may include a sequence of a rising period and a falling period. During the rising period, a voltage of the X electrode and a voltage of the A electrode may be maintained at a reference voltage (e.g., ground voltage 0V, as depicted in FIG. 2), and a voltage of the Y electrode may be gradually increased from a Vs voltage to a Vset voltage. When the voltage of the Y electrode increases, a weak discharge is generated between the Y electrode and the X electrode and between the Y electrode and the A electrode, and thus negative (−) wall charges are formed on the Y electrode and positive (+) wall charges are formed on the X and A electrodes.

During a falling period of the reset period, the voltage of the Y electrode may be gradually decreased from the Vs voltage to a Vnf voltage while the voltage of the A electrode may be maintained at the reference voltage and a Ve voltage is applied to the X electrode. Then, a weak discharge is generated between the Y and X electrodes and between the Y and A electrodes while the voltage of the Y electrode is gradually decreased, and accordingly the negative wall charges formed on the Y electrode and the positive wall charges formed on the X and A electrodes are erased. In general, a (Vnf-Ve) voltage is set close to a discharge firing voltage Vfxy between the Y electrode and the X electrode. Then, a wall voltage between the Y electrode and the X electrode becomes close to 0 V so that misfiring of a cell (which has not experienced an address discharge in the address period) in the sustain period may be reduced or prevented.

In the address period, a scan pulse with the VscL voltage may be sequentially and selectively applied to one or more Y electrodes while the Ve voltage is applied to the X electrode so as to select discharge cells to be turned on. At this time, a Va voltage may be applied to the A electrode associated with the column of discharge cells amongst which one or more discharge cells are desired to emit. Then, an address discharge is generated between the A electrode to which the Va voltage is applied and the Y electrode to which the VscL voltage is applied and between the Y electrode to which the VscL voltage is applied and the X electrode to which the Ve voltage is applied. Accordingly, positive wall charges are formed on the Y electrode and negative wall charges are formed on the A and X electrodes. In this case, Y electrodes to which the VscL voltage is not applied instead may be maintained at a VscH voltage that is greater than the VscL voltage, and A electrodes associated with columns of discharge cells that are not desired to emit may be maintained at the reference voltage.

In order to perform the above-noted operation in the address period, the scan electrode driver 400 may select a Y electrode to which the scan pulse with the VscL voltage will be applied from among the Y electrodes Y1 to Yn. For example, vertically arranged Y electrodes may be sequentially selected in a signal driving algorithm. When one of Y electrodes is selected, the address electrode driver 300 selects turn-on discharge cells among discharge cells formed by the selected Y electrode. That is, the address electrode driver 300 selects a discharge cell to which an address pulse having the Vs voltage among the A electrodes A1 to Am is to be applied.

During the sustain period, a sustain discharge pulse alternately having a high level voltage (Vs voltage in FIG. 2) and a low level voltage (e.g., 0 V in FIG. 2) are applied to the Y electrode and the X electrode, respectively. The sustain discharge pulse applied to the Y electrode has a reverse phase relative to the sustain discharge pulse applied to the X electrode. The sustain pulse has a cycle of length, e.g., 2T1. Initially (for a first time span of magnitude T1), the Vs voltage may be applied to the Y electrode and 0 V may be applied to the X electrode and then (for a second time span of magnitude T1) 0 V may be applied to the Y electrode and the voltage Vs may be applied to the X electrode, thus sustain discharges are generated between the Y and X electrodes. Accordingly, negative wall charges are formed on the Y electrode and positive wall charges are formed on the X electrode for the first time span (again, of magnitude T1) and vice-versa for the second time span (again, of magnitude T1). A process that applies the sustain discharge pulse to the Y electrode and the X electrode is repeated a number of times corresponding to a weight of the corresponding subfield. In general, the sustain pulse may be a square wave having a voltage magnitude Vs and a period 2T1.

Table 1 shows examples of weights and numbers of sustain discharge pulses for respective subfields in one frame. In Table 1, it is assumed that one frame is divided into ten subfields.

TABLE 1

| | | Number of sustain |
|---|---|---|
| Subfield | Weight | discharge pulses |
| SF0 | 1 | 2 |
| SF1 | 5 | 12 |
| SF2 | 11 | 25 |
| SF3 | 24 | 56 |
| SF4 | 46 | 107 |
| SF5 | 80 | 185 |
| SF6 | 128 | 296 |
| SF7 | 180 | 417 |
| SF8 | 242 | 560 |
| SF9 | 302 | 699 |

As shown in Table 1, the number of sustain discharge pulses for a sustain period increases as a weight of the corresponding subfield increases. As the number of sustain discharge pulses applied to one subfield increases, luminance increases. However, when the number of sustain discharge pulses applied to one subfield is greater than a reference number, a light saturation phenomenon may occur and phosphor inside the discharge cell may be saturated. For example, assume that the reference number is 200. In this assumption, the light saturation phenomenon may occur in the sixth subfield SF6 to the ninth subfield SF9 where the number of sustain discharge pulses respectively exceeds the reference number. Then, in the sixth subfield SF6 to the ninth subfield SF9, a luminance inversion phenomenon may occur so that the luminance is not increased but decreased in proportion to the number of sustain discharge pulses.

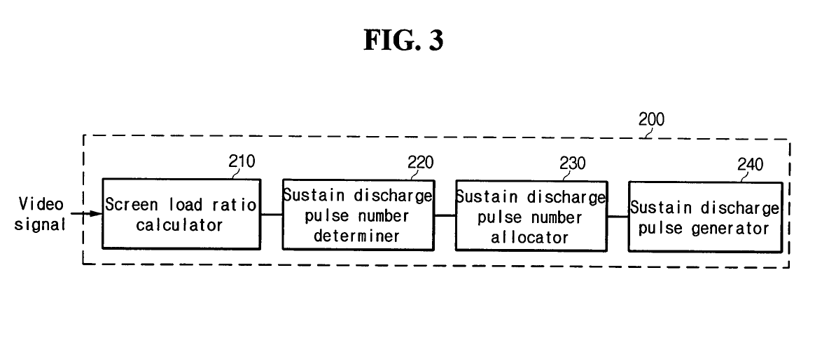

A method, for preventing a luminance inversion phenomenon by changing a width of a sustain discharge pulse in a subfield where the number of allocated sustain discharge pulses is greater than a reference number of sustain discharge pulses will be described with reference to FIG. 3 to FIG. 5. In this embodiment, the reference number may be set to the minimum number of sustain discharge pulses that may cause the luminance inversion phenomenon in one subfield.

FIG. 3 illustrates a block diagram of the controller 200 according to an example embodiment of the present invention.

In FIG. 3, elements of the controller that are tangential to a description of this embodiment have been omitted for brevity. As shown in FIG. 3, the controller 200 may include a screen load ratio calculator 210, a sustain discharge pulse number determiner 220, a sustain discharge pulse number allocator 230, and a sustain discharge pulse generator 240.

The screen load ratio calculator 210 may calculate a screen load ratio corresponding to one frame of an externally input image.

The sustain discharge pulse number determiner 220 may calculate a total number of sustain discharge pulses to be allocated to one frame based on the calculated screen load ratio.

The sustain discharge pulse number allocator 230 may calculate the number of sustain discharge pulses to be allocated to the subfields, respectively, based on the total number of sustain discharge pulses allocated to one frame.

The sustain discharge pulse generator 240 may set a width of respective sustain pulses to a first pulse width when the number of sustain discharge pulses allocated to a given subfield is less than the reference number. In addition, when the number of sustain discharge pulses allocated to a given subfield is greater than the reference number, the sustain discharge pulse generator 240 may set some of the sustain discharge pulses to have the first pulse width and the rest of the sustain discharge pulses to have a second pulse width that is greater than the first pulse width, respectively.

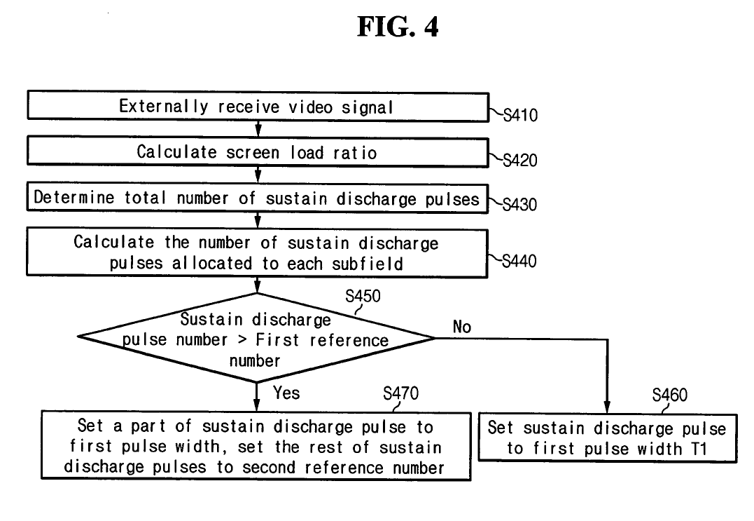

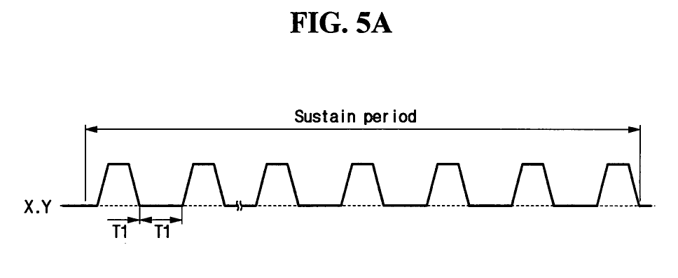

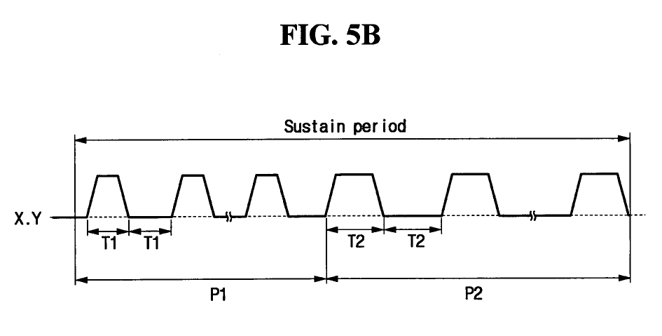

FIG. 4 illustrates an operational flowchart of the controller 200 according to an example embodiment of the present invention, and 5A and FIG. 5B show a sustain discharge pulse in a sustain period according to an example embodiment of the present invention.

In a sustain period of FIG. 5A, the number of sustain discharge pulses allocated to one subfield is less than the reference number. In a sustain period of FIG. 5B, the number of sustain discharge pulses allocated to one subfield is greater than the reference number.

As shown in FIG. 4, when an external video signal is input to the controller 200 in step S410, the screen load ratio calculator 210 of the controller 200 calculates a screen load ratio of a video signal input for one frame in step S420. The screen load ratio may be calculated, e.g., by using an average signal level (ASL), and the average signal level may be calculated by using Equation 1.

$$A S L = \frac{{\sum }_{i = 1}^{N} {R}_{i} + {G}_{i} + {B}_{i}}{3 N} \qquad [ Equation 1 ]$$

In Equation 1, Ri, Gi, and Bi respectively denote a video signal of the i^{th} red (R) discharge cell, the i^{th} green (G) discharge cell, and the i^{th} blue (B) discharge cell in one frame, and N denotes the number of video signals input for one frame.

The sustain discharge pulse number determiner 220 may determine a total number of sustain discharge pulses to be allocated to one frame according to the screen load ratio calculated by the screen load ratio calculator 210, in step S430. For example, the sustain discharge controller 220 may store in advance (e.g., via a look-up table (LUT)), candidate values for the total number of sustain discharge pulses and then may use the screen load ratio to index into the LUT and thereby select an appropriate total number of sustain discharge pulses from among the candidate values. Alternatively, the sustain discharge controller 220 may calculate the total number of sustain discharge pulses by applying a logic operation to the screen load ratio. When the screen load ratio of an input video signal increases, power consumption also increases, and therefore the sustain discharge pulse number determiner 220 may set the total number of sustain discharge pulses allocated to one frame to be relatively low when the screen load ratio is relatively high so as to maintain the power consumption at a substantially constant level.

The sustain discharge pulse number allocator 230 may allocate the total sustain discharge pulses allocated for one frame to the subfields corresponding to a weights of the subfields, respectively, in step S440.

Subsequently, the sustain discharge pulse generator 240 may compare the number of sustain discharge pulses allocated to a given subfield by the sustain discharge pulse number allocator 230 with the reference number, in step S450. When the number of sustain discharge pulses allocated to a subfield is less than the reference number, the sustain discharge pulse generator 240 may set a width of the respective sustain discharge pulses to a first pulse width T1 as shown in FIG. 5A, in step S460. However, when the number of sustain discharge pulses allocated to the subfield is greater than the reference number, the sustain pulse generator 240 may set a cycle of a sustain discharge pulse applied to each electrode during a first interval P1 as, e.g., a first value 2T1 and a cycle of a sustain discharge pulse applied to each electrode during a second interval P2 as, e.g., a second value 2T2 where T2>T1, in step S470.

In this case, during the first interval P1 in the sustain period, the number of sustain discharge pulses applied to the respective electrode for a given subfield does not exceed the reference number (which, again, represents a maximum number of sustain discharge pulses that can be applied consecutively during a sustain period without causing the luminance inversion phenomenon absent some other compensation technique, e.g., such as discussed herein). During the second interval P2 of the sustain period, quantities of sustain discharge pulses applied to the respective electrode for the given subfield exceed the reference number.

In further detail (by way of an example), let it be assumed that the reference number is set to 200, and the first interval P1 is driven in the sustain period of the 0-th subfield SF0 to the fifth subfield SF5 where the number of allocated sustain discharge pulses is less than the reference number as shown in Table 1. In the sustain period of the sixth subfield SF6 to the ninth subfield SF9 where the number of allocated sustain discharge pulses is greater than the reference number, respectively, the first interval P1 and the second interval P2 are driven. Since the number of sustain discharge pulses of the respective subfields SF6 to SF9 is greater than the reference number, the first intervals P1 of the respective subfields SF6 to SF9 correspond to each other. However, the second interval P2 of the respective subfields SF6 to SF9 is changed according to the number of sustain discharge pulses applied to a given subfield. That is, the second interval P2 increases as the sustain discharge pulses increase. In Table 1, the second interval P2 is more increased in the ninth subfield SF9 than in the sixth subfield SF6.

The sustain discharge becomes strong with an increase of a pulse width, and luminance increases as the sustain discharge becomes stronger. Therefore, the cycle length of the sustain pulse is set to be 2T1 when the number of sustain discharge pulses is less than the reference number in this example embodiment. Then, a sustain discharge is generated during a period corresponding to the first pulse width T1 so that the discharge cell selected in the address period is discharged. When the number of sustain discharge pulses is greater than the reference number, the cycle length of sustain discharge pulses generated during the first interval P1 is set to be 2T1, and the cycle length of those sustain discharge pulses generated during the second interval P2 is set to be 2T2. Since sustain discharge pulses having the cycle 2T2 are applied during the interval P2, occurrence of the luminance inversion phenomenon can be reduced (if not prevented). Again, an advantage of reducing (if not preventing) the luminance inversion phenomenon is doing so avoids the luminance being decreased in proportion to the number of sustain discharge pulses rather than being increased.

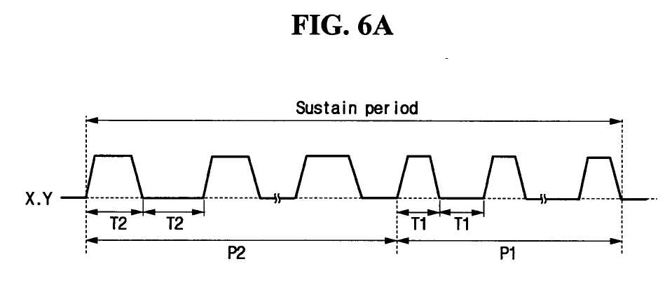

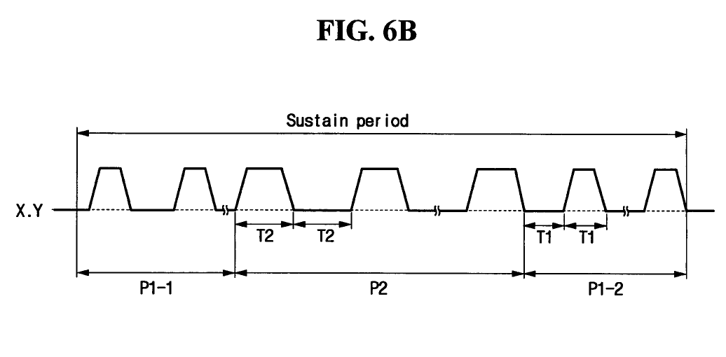

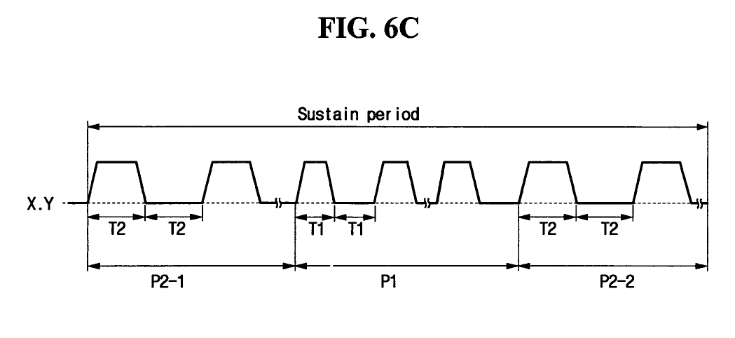

It is illustrated in FIG. 5B that the second interval P2 is driven after the first interval P1 is driven in a sustain period of a subfield where the number of sustain discharge pulses is greater than the reference number. However, the driving order of the first interval P1 and the second interval P2 may be varied as shown in FIG. 6A to FIG. 6C.

FIG. 6A to FIG. 6C illustrate driving forms of sustain discharge pulses in a sustain period according to example embodiments of the present invention.

As shown in FIG. 6A, the sustain pulse generator 240 of the controller 200 may set the first interval P1 to be driven after the second interval P2 is driven during the sustain period.

As shown in FIG. 6B, the sustain pulse generator 240 of the controller 200 may divide the first interval P1 into sub-intervals P1-1 and P1-2, and then intersperse the second interval P2 between the sub-intervals P1-1 and P1-2.

As shown in FIG. 6C, the sustain discharge pulse generator 240 of the controller 200 may divide the second interval P2 into sub-intervals P2-1 and P2-2, and then intersperse the first interval P1 between the sub-intervals P2-1 and P2-2.

Again, the reference number of the sustain discharge pulses represents a maximum number of sustain discharge pulses that can be applied consecutively in a sustain period without causing the luminance inversion phenomenon absent some other compensation technique, e.g., such as discussed herein. The reference number can be experimentally obtained, and a method for obtaining the reference number is well known to a person skilled in the art, and therefore further description will be omitted for the sake of brevity.

As described above, according to one or more example embodiments of the present invention, reduction in luminance can be reduced (if not prevented) regardless of the number of sustain discharge pulses generated during a given sustain period by increasing a cycle length of those sustain discharge pulses generated after the count of sustain discharge pulses exceeds a reference number.

Example embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A driving method of a plasma display device having a first electrode and a second electrode, a frame for display being divided into a plurality of subfields, the method comprising:
determining a number of sustain discharge pulses to be allocated to the subfields, respectively; and
applying to the first electrode or the second electrode, during a sustain period for a given one of the subfields when the corresponding allocated number of sustain discharge pulses is greater than a reference number, a first quantity of first sustain discharge pulses each having a first cycle and a second quantity of second sustain discharge pulses each having a second cycle,
the second cycle being different from the first cycle and
the first quantity of first sustain discharge pulses relating to the reference number.

2. The driving method as claimed in claim 1, wherein applying includes:
dividing the sustain period into first and second intervals; and
providing the first sustain discharge pulses in the first interval and the second sustain discharge pulses in the second interval.

3. The driving method as claimed in claim 2, wherein the first interval occurs before the second interval.

4. The driving method as claimed in claim 1, wherein applying includes:
dividing the sustain period into first, second and third intervals; and
providing one of the first sustain discharge pulses and the second sustain discharge pulses in the second interval; and
providing first and second portions of the other of the first sustain discharge pulses and the second sustain discharge pulses in the first and third interval intervals, respectively.

5. The driving method as claimed in claim 1, wherein:
the second sustain discharge pulses are provided in the second interval; and
first and second portions of the first quantity of first sustain discharge pulses are provided in the first and third interval intervals, respectively.

6. The driving method as claimed in claim 1, wherein the first cycle is shorter than the second cycle.

7. The driving method as claimed in claim 1, wherein the second interval is determined according to a weight of the given subfield.

8. The driving method as claimed in claim 1, wherein the reference number corresponds to a maximum number of sustain discharge pulses that can be applied consecutively to the first and second electrodes in the sustain period before a luminance inversion phenomenon.

9. The driving method as claimed in claim 1, wherein determining the number of sustain discharge pulses allocated to the respective subfields includes:
calculating a total number of sustain discharge pulses that are to be allocated to one frame corresponding to an externally input video signal; and
calculating the number of sustain discharge pulses applied during the sustain period of the given subfield by dividing the total number of sustain discharge pulses in proportion to a weight of the given subfield.

10. The driving method as claimed in claim 9, wherein calculating the total number of sustain discharge pulses allocated to the frame comprises:
calculating a screen load ratio that corresponds to the external input video signal during one frame; and
determining a total number of sustain discharge pulses allocated to one frame based on the screen load ratio.

11. A plasma display device, comprising:
a plasma display panel (PDP) having a first electrode and a second electrode; and
a controller adapted to,
divide one frame into a plurality of subfields,
determine a number of sustain discharge pulses to be allocated to the subfields, respectively, and
apply to the first electrode or the second electrode, during a sustain period for a given one of the subfields when the corresponding allocated number of sustain discharge pulses is greater than a reference number, a first quantity of first sustain discharge pulses each having a first cycle and a second quantity of second sustain discharge pulses each having a second cycle;
the second cycle being different from the first cycle; and
the first quantity of first sustain discharge pulses relating to the reference number.

12. The plasma display device as claimed in claim 11, wherein the controller is further adapted to:
divide the sustain period into first and second intervals; and
provide the first sustain discharge pulses in the first interval and the second sustain discharge pulses in the second interval.

13. The plasma display device as claimed in claim 11, wherein the first interval occurs before the second interval.

14. The plasma display device as claimed in claim 11, wherein the controller is further adapted to:
divide the sustain period into first, second and third intervals; and
provide one of the first sustain discharge pulses and the second sustain discharge pulses in the second interval; and
provide first and second portions of the other of the first sustain discharge pulses and the second sustain discharge pulses in the first and third interval intervals, respectively.

15. The plasma display device as claimed in claim 11, wherein:
the second sustain discharge pulses are provided in the second interval; and
first and second portions of the first quantity of first sustain discharge pulses are provided in the first and third interval intervals, respectively.

16. The plasma display device as claimed in claim 11, wherein the first cycle is smaller than the second cycle.

17. The plasma display device as claimed in claim 11, wherein the controller is further operable to determine the second interval according to a weight of the given subfield.

18. The plasma display device as claimed in claim 11, wherein the controller sets a period during which a number of sustain discharge pulses among the sustain discharge pulses allocated to the first subfield is applied, excluding the reference number of sustain discharges.

19. The plasma display device as claimed in claim 11, wherein the controller is further adapted to;
calculate a total number of sustain discharge pulses that are to be allocated to one frame corresponding to an external input video signal,
divide the total number of sustain discharge pulses in proportion to a weight of the given subfield to form a quotient, and
set a number of sustain discharge pulses applied during the sustain period of the given subfield according to the quotient.

20. The plasma display device as claimed in claim 11, wherein the controller is adapted to determine the number of sustain discharge pulses to be allocated to the subfields, respectively, by including:
calculating a screen load ratio that corresponds to the external input video signal during one frame; and
determining a total number of sustain discharge pulses allocated to one frame based on the screen load ratio.
